(19) United States
(12) Patent Application Publication
(10) Pub. No.: US 2012/0239816 A1
(43) Pub. Date: Sep. 20, 2012

(54) METHOD AND APPARATUSES FOR TDF SESSION ESTABLISHMENT

(75) Inventors: Roberto David Carnero Ros, Madrid (ES); Maria Belen Pancorbo Marcos, Madrid (ES)

(73) Assignee: TELEFONAKTIEBOLAGET LM ERICSSON (PUBL), Stockholm (SE)

(21) Appl. No.: 13/254,042

(22) PCT Filed: Jul. 22, 2011
(86) PCT No.: PCT/EP11/62687

§ 371 Date: Jan. 3, 2012

Related U.S. Application Data
(60) Provisional application No. 61/454,167, filed on Mar. 18, 2011.

(51) Int. Cl. G06F 15/16

(52) U.S. Cl. 709/227

(57) ABSTRACT

The present invention faces the issue of racing conditions occurring during the establishment of an IP-CAN session in PCC architecture and a TDF session between a PCRF and a TDF of the PCC architecture. To overcome this issue, the present invention provides for cooperating apparatuses carrying out a method of establishing a Traffic Detection Function “TDF” session in a Policy and Charging Control “PCC” architecture with a Policy and Charging control Rules Function “PCRF”, a Policy and Charging Enforcement Function “PCEF” and a TDF, the method comprising the steps of: signalling an IP-CAN session establishment from a PCEF towards a PCRF; selecting at the PCRF a TDF for detecting and reporting traffic through the IP-CAN session; initiating from the PCRF establishment of a TDF session with the TDF; submitting from the PCRF towards the TDF the ADC rules to be installed for the IP-CAN session; and submitting from the PCRF towards the PCEF the PCC rules to be installed for the IP-CAN session. This method thus ensures that the TDF session has been established before having completed the establishment of the IP-CAN session.

### TECHNICAL FIELD

The present invention generally relates to establishment of a session between a Policy and Charging control Rules Function (hereinafter PCRF) and a Traffic Detection Function (hereinafter TDF). More specifically, the invention relates to establishment of a TDF session between a PCRF server and a TDF device.

### BACKGROUND

The 3GPP TS 23.203 v11.0.1 introduces a Traffic Detection Function (TDF) as part of the 3GPP Release 11 for Policy and Charging Control (PCC) architecture. The aim of such functionality is to make the network be service aware in order to enhance user experience.

Conventionally, and for the purpose of the present invention, the Policy and Charging Control (PCC) architecture includes a Policy and Charging Enforcement Function (PCEF) in charge of traffic flow detection and enforcement of applicable policies to user traffic flows, a Policy and Charging Rules Function (PCRF) in charge of providing network control for the traffic flow detection by holding policies and providing PCC rules to the PCEF per user traffic flow basis for enforcement of such policies, and a Traffic Detection Function (TDF) responsible of performing application detection and reporting detected applications and service data flow descriptions to the Policy and Charging Rules Function (PCRF) for the latter to provide new policies to be enforced by a Policy and Charging Enforcement Function (PCEF).

3GPP TS 23.203 v11.0.1 describes two ways for the TDF reporting to the PCRF: “Unsolicited”, whereby services to be detected by the TDF are pre-configured in the TDF and are applicable for all users; and “Solicited”, whereby services to be detected are provisioned by the PCRF on a per user and IP-CAN session basis through provisioning of so-called Application and Detection Control (ADC) Rules to the TDF.

Conventionally, the TDF makes use of ADC Rules for notifying the PCRF of the beginning and end of application traffic. That is, the ADC Rules can be used for identifying Layer 7 applications. In this respect, ADC rules can be used by Deep Packet Inspection (DPI) methods for traffic identification and classification. On the other hand, the PCC Rules are significantly simpler than the ADC rules since the PCC rules deal with a Layer 3 Filter or IP 5-tuple. For example, an access to two different applications may be identified just by one single PCC Rule, while two ADC Rules will be needed for identifying the application properly (for instance, distinguishing between Skype and MSN on top of HTTP traffic).

Moreover, the ADC rules can be applied for all traffic in a whole IP-CAN session, whereas the PCC rules are associated with one bearer each, thus not likely being applicable for the whole IP-CAN session. Furthermore, the FCC Rules also include parameters for service data flows, for example GBR, which are irrelevant for service awareness.

3GPP TS 23.203 v11.0.1 also defines two different ways for deploying the TDF function: in a first way there is a PCEF with ADC capabilities, which is referred to as ‘a TDF collocated with the PCEF’ or as a ‘TDF-PCEF’ throughout this specification; in a second way there is a TDF, which is referred to as a ‘standalone TDF’ or simply as ‘TDF’ throughout this specification. For the TDF collocated with the PCEF, at IP-CAN Session establishment, the PCRF may provide the ADC Rules together with the PCC Rules to the TDF-PCEF. But for the standalone TDF, a so-called TDF session should be established in order to install the ADC Rules.

At present, the establishment of a TDF session for a standalone TDF and the provision of ADC rules are not specified in 3GPP yet.

One may think that, upon IP-CAN Session Establishment, the PCRF could make a TDF selection and provide the TDF Address to the PCEF in its response. The PCEF then could route all the traffic for such IP-CAN session towards the selected TDF. So that where the TDF detects the first data flow for the uplink traffic, the TDF initiates the TDF session and requests the ADC Rules to the PCRF.

However, this approach is vulnerable to racing conditions, since the TDF session is established when the first data flows for the IP-CAN session reaches the TDF, and there could be data flows reaching an Application Function (AF) of the PCC architecture before the ADC Rules are installed and before the service can thus be detected. This behaviour could violate specific ADC Rules and is thus not a suitable solution.

### SUMMARY

The present invention is aimed to at least minimize the above drawbacks and provides for a new method of establishing a TDF session in PCC architecture with a standalone TDF device and with enhanced PCEF device and PCEF server, they all arranged to support said method.

Throughout this specification, a PCRF server is a network element arranged for carrying out the functionality of a PCRF in accordance with conventional PCC standards; a PCEF device is a network element arranged for carrying out the functionality of a PCEF in accordance with conventional PCC standards; and a TDF device is a network element arranged for carrying out the functionality of a TDF in accordance with conventional PCC standards. In addition, the PCRF server, the PCEF device and the TDF device throughout this specification are enhanced to accomplish the objects of the present invention.

In accordance with a first aspect of the present invention, there is provided a new method of establishing a TDF session in a PCC architecture with a PCRF server, a PCEF device and a TDF device as claim 1 recites.

This method comprises the steps of: signalling an IP-CAN session establishment from a PCEF device towards a PCRF server; selecting at the PCRF server a TDF device for detecting and reporting traffic through the IP-CAN session; initiating from the PCRF server establishment of a TDF session with the TDF device; submitting from the PCRF server towards the TDF device ADC rules to be installed for the IP-CAN session; and submitting from the PCRF server towards the PCEF device PCC rules to be installed for the IP-CAN session.

In order to more precisely trigger the submission of PCC rules towards the PCEF device, this method may further comprise a step of determining at the PCRF server that the ADC rules have been successfully installed at the TDF device. Where this is the case, the step of submitting the PCC rules to the PCEF device is responsive to the step of determining that the ADC rules have successfully been installed at the TDF device.

Different embodiments are provided for in order to initiate the establishment of the TDF session. Nevertheless, and irrespective of the embodiment followed, the step of submitting the ADC rules may be carried out during the step of initiating from the PCRF server the establishment of the TDF session towards the TDF device.

In one embodiment, the step of initiating the establishment of the TDF session may include a step of requesting from the PCRF server to the TDF device the establishment of the TDF session. Where this is the case, the step of submitting the ADC rules may be carried out during the step of requesting from the PCRF server to the TDF device the establishment of the TDF session.

In another embodiment, the step of initiating the establishment of the TDF session may include a step of notifying from the PCRF server the needs for a TDF session to the TDF device and a step of requesting the establishment of the TDF session from the TDF device to the PCRF server. Where this is the case, the step of submitting the ADC rules is responsive to the step of requesting the establishment of the TDF session from the TDF device to the PCRF server.

Generally speaking for this method, the step of submitting the ADC rules may be responsive to a step of requesting ADC rules from the TDF device to the PCRF server, request for ADC rules which can be carried out at any time during the existence of the IP-CAN session.

On the other hand, different embodiments are provided for in order to select a TDF device at the PCRF server. In one embodiment, the step of selecting a TDF device at the PCRF server may include a step of receiving TDF information during the step of signalling the IP-CAN session establishment from the PCEF device; whereas in another embodiment, the step of selecting a TDF device at the PCRF server may include a step of obtaining TDF information from a Subscriber Profile Repository “SPR” in charge of subscription information for a subscriber related to the IP-CAN session. Nonetheless, combination of both embodiments is perfectly possible and advantageous in order to achieve the most suitable selection of a TDF device for any IP-CAN session.

In accordance with a second aspect of the present invention, there is provided a new PCRF server of a PCC architecture with a PCEF device and a TDF device.

This PCRF server comprises: a first interface unit for signalling establishment of an IP-CAN session from a PCEF device; a processing unit for selecting a TDF device to detect and report traffic through the IP-CAN session, for determining PCC rules to be installed at the PCEF device, and for determining ADC rules to be installed at the TDF device; a second interface unit for initiating establishment of a TDF session with the TDF device and for submitting towards the TDF device the ADC rules to be installed for the IP-CAN session; and wherein the first interface unit is arranged for submitting towards the PCEF device the PCC rules to be installed for the IP-CAN session.

For the sake a more precise submission of PCC rules towards the PCEF device, the processing unit of the PCRF server may be arranged for determining that the ADC rules have successfully been installed at the TDF device and, responsive to this determination, for triggering the submission of the PCC rules through the first interface unit towards the PCEF device.

In order to carry out the different embodiments provided for in order to initiate the establishment of the TDF session, the second interface unit of the PCRF server may be arranged for requesting the establishment of the TDF session to the TDF device. Where this is the case, this second interface unit may be arranged for submitting the ADC rules to the TDF device along with the request for the establishment of the TDF session.

Alternatively or complementary, the second interface unit of the PCRF server may be arranged for notifying the TDF device of the needs for a TDF session, and for receiving a request for establishment of the TDF session from the TDF device. Where this is the case, this second interface unit may be arranged for submitting the ADC rules to the TDF device upon receiving the request for establishment of the TDF session from the TDF device.

In particular, and aligned with corresponding technical features of the above method, the second interface unit may be arranged for submitting the ADC rules as initiating the establishment of the TDF session towards the TDF device.

Nevertheless, the second interface unit of the PCRF server may be arranged for submitting the ADC rules to the TDF device upon request from the TDF device, at any time during the existence of the IP-CAN session.

On the other hand, in order to select a TDF device at the PCRF server, several embodiments and combinations thereof are provided for.

In one embodiment, the processing unit of the PCRF server may be arranged for selecting the TDF device by processing TDF information received at the first interface unit from the PCEF device along with the signalled IP-CAN session establishment.

In other embodiment, the PCRF server may further comprise a third interface unit for obtaining TDF information from a Subscriber Profile Repository “SPR” in charge of subscription information for a subscriber related to the IP-CAN session. Where this is the case, the processing unit of the PCRF server may be arranged for selecting the TDF device by processing the TDF information obtained at the third interface unit from the SPR.

These two embodiments for selecting the TDF device may be combined so that the processing unit may be arranged for selecting the TDF device by processing both the TDF information received at the first interface unit from the PCEF device and the TDF information obtained at the third interface unit from the SPR.

In accordance with a third aspect of the present invention, there is provided a new TDF device of a PCC architecture with a PCRF server and PCEF device.

This TDF device comprises: an interface unit for initiating establishment of a TDF session with a PCRF server, and for receiving ADC rules for an IP-CAN session from the PCRF server; a processing unit for installing the ADC rules for the IP-CAN session; and a detector for detecting traffic through the IP-CAN session based on the installed ADC rules.

Correspondingly with technical features of the PCRF server and the method, the interface unit of the TDF device may be arranged for notifying the PCRF server of a successful installation of the ADC rules for the IP-CAN session.

Likewise, in order to carry out the different embodiments provided for in order to initiate the establishment of the TDF session, the interface unit of the TDF device may be arranged for receiving the request for establishment of the TDF session from the PCRF server. Where this is the case, the ADC rules may be received at this interface unit from the PCRF server along with the request for establishment of the TDF session.

Alternatively or complementary, the interface unit of the TDF device may be arranged for receiving the notification of the needs for a TDF session from the PCRF server, and for submitting the request for establishment of the TDF session to the PCRF server. Where this is the case, the ADC rules may be received at this interface unit from the PCRF server as a result of submitting the request for establishment of the TDF session to the PCRF server.

Generally speaking, and combinable with any embodiment discussed above in respect of the establishment of a TDF session between the PCRF server and the TDF device, the interface unit of the TDF device may be arranged for submitting a request for the ADC rules to the PCRF server at any time during the existence of the IP-CAN session.

On the other hand, the invention may be practised by a computer program, in accordance with a fourth aspect of the invention, the computer program being loadable into an internal memory of a computer with input and output units as well as with a processing unit, and comprising executable code adapted to carry out the above method steps. In particular, this executable code may be recorded in a carrier readable in the computer.

### BRIEF DESCRIPTION OF THE DRAWINGS

The features, objects and advantages of the invention will become apparent by reading this description in conjunction with the accompanying drawings, in which:

FIG. 1 basically represents a method of establishing a TDF session in PCC architecture with a TDF device and with enhanced PCEF device and PCEF server.

FIG. 2 shows an exemplary sequence of actions that may be performed as part of the method illustrated in FIG. 1.

FIG. 3 shows an exemplary sequence of actions in accordance with a first embodiment of the method illustrated in FIG. 1.

FIG. 4 shows an exemplary sequence of actions in accordance with a second embodiment of the method illustrated in FIG. 1.

FIG. 5 illustrates the method of FIG. 1 in a particular scenario where a Bearer Binding and Event Reporting Function (BBERF) of a PCC architecture initiates a Gateway Control Session Establishment procedure.

FIG. 6 shows an exemplary sequence of actions in accordance with a third embodiment of the method illustrated in FIG. 1.

FIG. 7 shows basic structural components of a PCRF server.

FIG. 8 shows basic structural components of a TDF device.

### DETAILED DESCRIPTION

The following describes currently preferred embodiments of a PCRF server, a PCEF device and a TDF device; they all arranged to carry out a method of establishing a TDF session in PCC architecture.

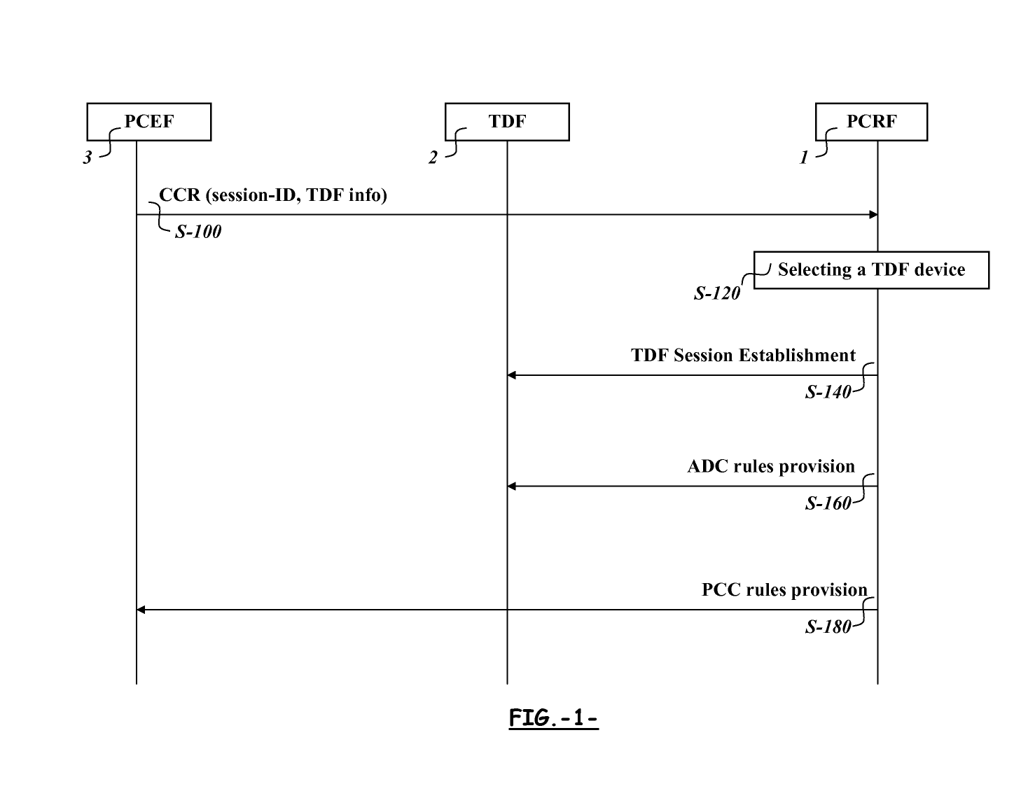

FIG. 1 illustrates a basic sequence of actions to be carried out for accomplishing this method. The sequence of actions starts when a PCEF device 3 is aware that a user has initiated the establishment of an IP Connectivity Access Network “IP-CAN” session, and the PCEF device signals the establishment of the IP-CAN session towards the PCRF server 1 during a step S-100. In particular, as signalling the establishment of the IP-CAN session, the PCEF device may provide a session-ID identifying the IP-CAN session. More particularly, the PCEF device may also optionally provide, in accordance with embodiments of the invention, TDF-related information useful for the PCRF server to select a TDF device suitable for inspecting traffic through the IP-CAN session. The TDF-related information might be an IP address for addressing a particular TDF device or any other individual or group identifier that the PCRF server could make it use of to select the suitable TDF.

Upon being signalled about the establishment of the IP-CAN session, the PCRF server 1 selects during a step S-120 a TDF device 2 for detecting and reporting traffic through the IP-CAN session, and the PCRF server 1 initiates during a step S-140 the establishment of a TDF session with the selected TDF device 2. In particular, several embodiments will be further discussed throughout this specification regarding the initiation and completion of the TDF session between the PCRF server 1 and the selected TDF device 2. Apart from initiating the establishment of the TDF session, the PCRF server 1 submits during a step S-160 towards the TDF device Application and Detection Control “ADC” rules to be installed for the IP-CAN session.

Once the ADC rules have been submitted from the PCRF server 1 to the TDF device 2, the PCRF server 1 submits during a step S-180 towards the PCEF device 3 the PCC rules to be installed for the IP-CAN session therein.

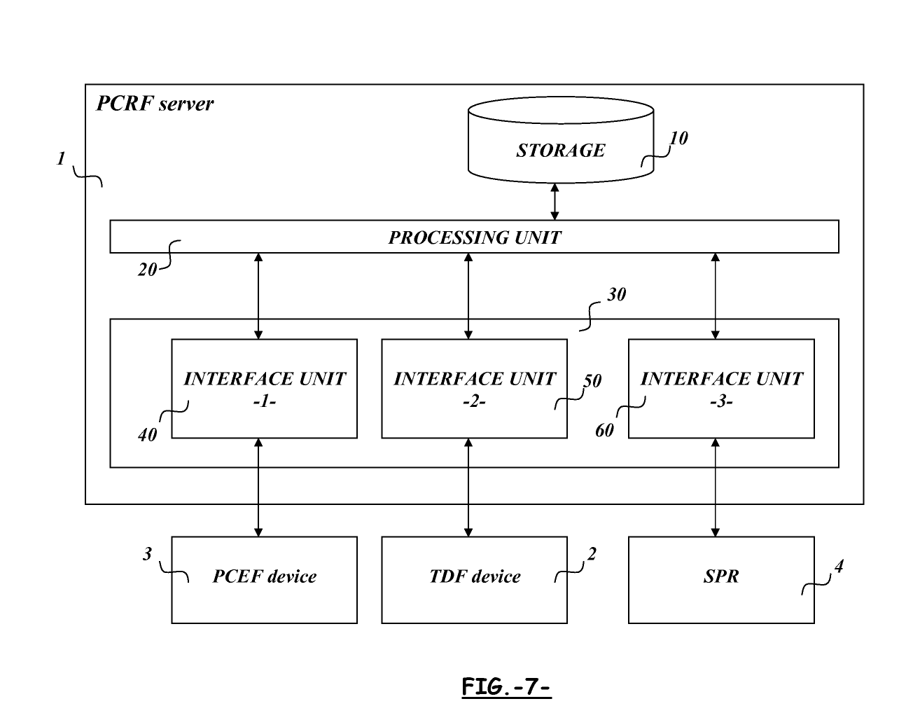

To this end, as illustrated in FIG. 7, the PCRF server 1 comprises in accordance with the invention: a first interface unit 40 for signalling the establishment of the IP-CAN session from the PCEF device 3; a processing unit 20 for selecting a TDF device to detect and report traffic through the IP-CAN session, for determining PCC rules to be installed at the PCEF device, and for determining ADC rules to be installed at the TDF device 2; a second interface unit 50 for initiating establishment of a TDF session with the TDF device 2 and for submitting towards the TDF device the ADC rules to be installed for the IP-CAN session; and wherein the first interface unit 40 is arranged for submitting towards the PCEF device 3 the PCC rules to be installed for the IP-CAN session. In particular, the first interface unit 40 and the second interface unit 50 may both be integral elements of a unique interface unit 30. Also in particular, the PCRF server 1 may include storage 10 to save relevant data, such as IP-CAN session data and TDF-related information, if received, to be further used during the step of selecting a TDF device 2 and/or during the step of initiating the establishment of the TDF session with the TDF device 2.

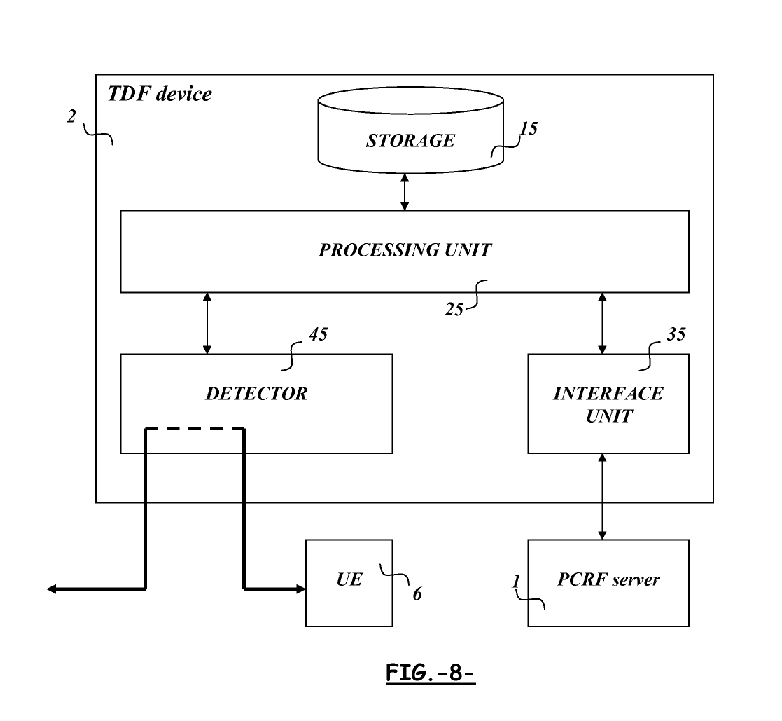

Also to this end, as illustrated in FIG. 8, the TDF device 2 comprises in accordance with the invention: an interface unit 35 for initiating establishment of a TDF session with a PCRF server 1, and for receiving ADC rules for an IP-CAN session from the PCRF server 1; a processing unit 25 for installing the ADC rules for the IP-CAN session; and a detector 45 for detecting traffic through the IP-CAN session based on the installed ADC rules.

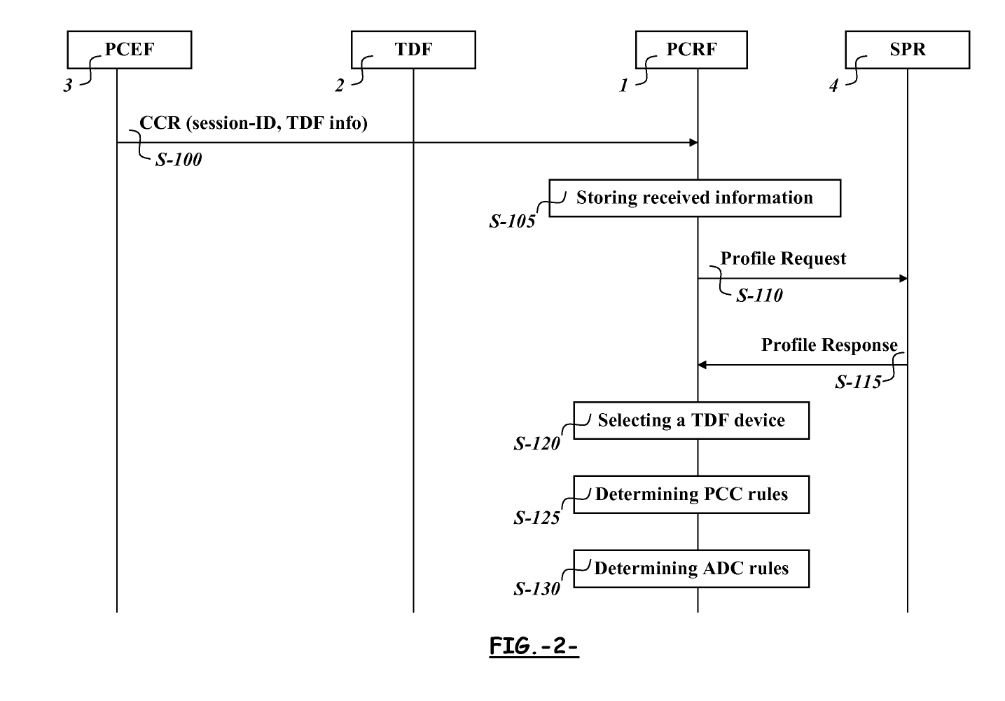

FIG. 2 illustrates a plurality of actions that may be optionally carried out at different steps and preferably before initiating the establishment of the TDF session between the PCRF server 1 and the TDF device 2.

For example, as illustrated in FIG. 2, upon receiving from the PCEF device a so-called CCR message indicating the establishment of the IP-CAN session for the user, the PCRF server 1 may store the received information during a step S-105. In particular, the CCR message might not include any TDF-related information. The PCRF server may then request a user profile for the user from a subscription profile repository “SPR” 4 during a step S-110.

Upon reception of the user profile for the user from the SPR 4 during a step S-115, the PCRF server 1 may make it use of information in the user profile for selecting a TDF device 2 for detecting and reporting traffic through the IP-CAN session as commented above with reference to FIG. 1.

The selection of a TDF device 2 by the PCRF server 1 may thus be carried out by taking into account TDF-related information received from the PCEF device 3, or by taking into account information included in a user profile for the user received from a SPR 4, or by taking into account TDF information configured or provisioned in the PCRF server 1, or any combinations thereof.

To this end, and with reference to FIG. 7, the PCRF server 1 may further comprise a third interface unit 60 for obtaining TDF information from the SPR 4 in charge of subscription information for a subscriber related to the IP-CAN session.

On the other hand, depending on the particular embodiment of the invention to be followed for a particular IP-CAN session and/or user, the processing unit 20 may be arranged for selecting the TDF device by processing the TDF information received at the first interface unit 40 from the PCEF device 3, along with the signalled IP-CAN session establishment, or may be arranged for selecting the TDF device by processing the TDF information obtained at the third interface unit 60 from the SPR 4, or may be arranged for selecting the TDF device by processing both TDF information received from the PCEF device 3 and TDF information received from the SPR 4, as well as by taking into account TDF information configured or provisioned in the PCRF server 1.

In particular, as already commented above, any amongst the first interface unit 40, the second interface unit 50 and the third interface unit 60 may be integral elements of a unique interface unit 30.

Moreover, the storage 10 of the PCRF server 1 may be arranged for storing TDF information received from the PCEF device 3 and TDF information received from the SPR 4.

Back to the sequence of actions illustrated in FIG. 2, at any time after having received the signalling from the PCEF device 3 informing of the establishment of an IP-CAN session for the user, and before submitting PCC rules towards the PCEF device 3, the PCRF server may determine the PCC rules to be installed at the PCEF device 3 during a step S-125.

Likewise, before or after having determined at the PCRF server 1 the PCC rules to be installed at the PCEF device 3, but in any case after having received the signalling from the PCEF device 3 informing of the establishment of an IP-CAN session for the user, and before submitting ADC rules towards the TDF device 2, the PCRF server may determine during a step S-130 the ADC rules to be installed at the TDF device 2.

To this end, and with reference to FIG. 7, the processing unit 20 of the PCRF server 1 is arranged for determining the PCC rules to be installed at the PCEF device 3 and for determining the ADC rules to be installed at the TDF device 2.

Alternatives to the embodiments described above with reference to FIG. 2 may be provided without departing from the scope of the invention. For example, in accordance with an embodiment of the invention, the PCEF device 3 may receive a request for IP-CAN Bearer establishment; the PCEF device may determine that a PCC authorization is required, so that the PCEF device may request the authorization of allowed services and PCC Rules information. It may also include the TDF IP address, in case of solicited application reporting, if applicable. The PCRF server 1 may store the received information; and, in case the PCRF server 1 does not have subscription related information, it may send a request to the SPR 4 in order to receive subscriber information related to the IP-CAN session. Once the PCRF server has received the requested subscriber information from the SPR, the PCRF server may make the authorization and policy decision. Then, the PCRF server 1 may select a TDF device 2 to be used for this IP-CAN session. The selection of the TDF device may be based on information stored in the SPR, which may be different than the TDF-related information received from the PCEF device. Apart from that, the PCRF may store the applicable PCC Rules for further submission to the PCEF device.

As already commented above, several embodiments are provided by the present invention regarding the initiation and completion of the TDF session between the PCRF server 1 and the selected TDF device 2.

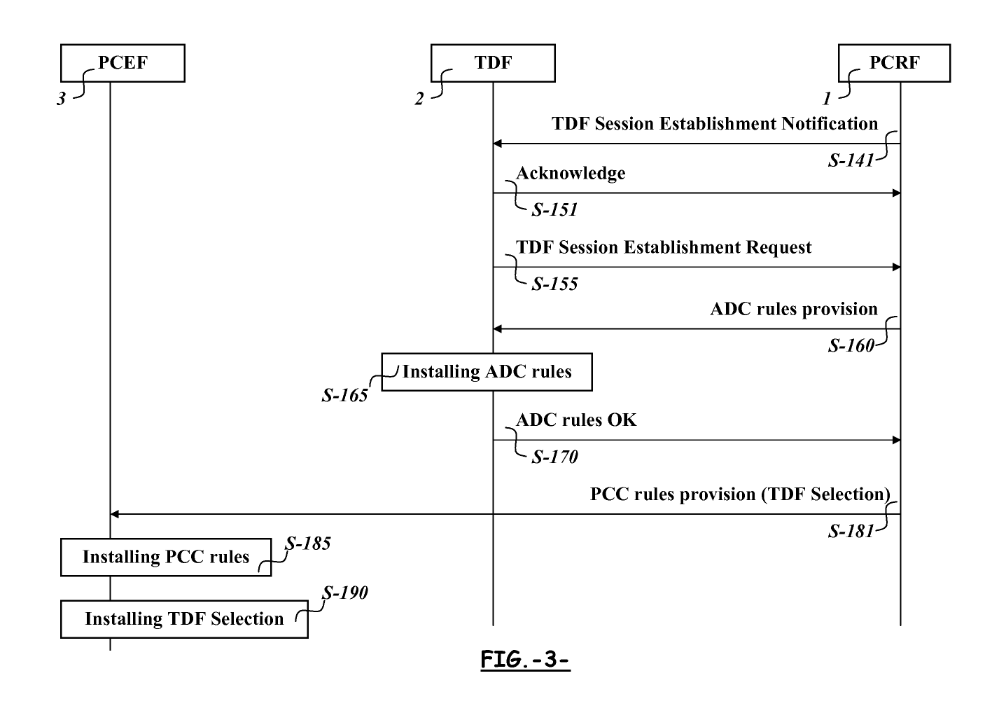

In a first embodiment illustrated in FIG. 3 and in order to initiate the establishment of the TDF session already discussed with reference to FIG. 1, the PCRF server 1 may notify the TDF device 2 during a step S-141 of the needs for a TDF session. The TDF device 2 may optionally acknowledge the notification during a step S-151, and may request during a step S-155 the establishment of the TDF session to the PCRF server 1.

In particular, the PCRF server 1 may submit the ADC rules during the step S-160 as a response to receiving during the step S-155 the request for establishment of the TDF session from the TDF device 2.

To this end, and with reference to FIG. 7, the second interface unit 50 of the PCRF server 1 may be arranged for notifying the TDF device 2 of the needs for a TDF session, and may be arranged for receiving a request for establishment of the TDF session from the TDF device 2. In particular for this embodiment, the second interface unit 50 may be arranged for submitting the ADC rules to the TDF device 2 upon receiving the request for establishment of the TDF session from the TDF device 2.

Also to this end, and with reference to FIG. 8, the interface unit 35 of the TDF device 2 may be arranged for receiving the notification of the needs for a TDF session from the PCRF server 1, and for submitting the request for establishment of the TDF session to the PCRF server 1. In particular for this embodiment, the interface unit 35 may be arranged for receiving the ADC rules from the PCRF server 1 as a result of having submitted the request for establishment of the TDF session to the PCRF server 1.

Back to the sequence of actions to be carried out in the exemplary embodiment illustrated in FIG. 3, upon receiving the ADC rules, the TDF device 2 installs the ADC rules during a step S-165.

Optionally, the TDF device 2 may confirm during a step S-170 to the PCRF server 1 that the ADC rules have been successfully installed so that, upon determining by the PCRF server 1 the successful installation of the ADC rules during this step S-170, the PCRF server 1 may responsively submit during the step S-180 the PCC rules towards the PCEF device 3.

In particular, as illustrated in FIG. 3, upon determining by the PCRF server 1 the successful installation of the ADC rules during this step S-170, the PCRF server 1 may submit during a step S-181 the PCC rules to the PCEF device 3 along with information related to the selected TDF device 2 for the PCEF device 3 to be enabled to communicate with the TDF device 2 either directly or indirectly though the PCRF server 1. Then, the PCEF device 3 may install the received PCC rules during a step S-185, and may install the received information related to the selected TDF device 2 during a step S-190.

To this end and with reference to FIG. 8, the interface unit 35 of the TDF device 2 may be arranged for notifying the PCRF server 1 of a successful installation of the ADC rules for the IP-CAN session.

Also to this end and with reference to FIG. 7, the processing unit 20 of the PCRF server 1 may be arranged for determining that the ADC rules have successfully been installed at the TDF device 2 and, responsive to this determination, for triggering the submission of the PCC rules through the first interface unit 40 towards the PCEF device 3.

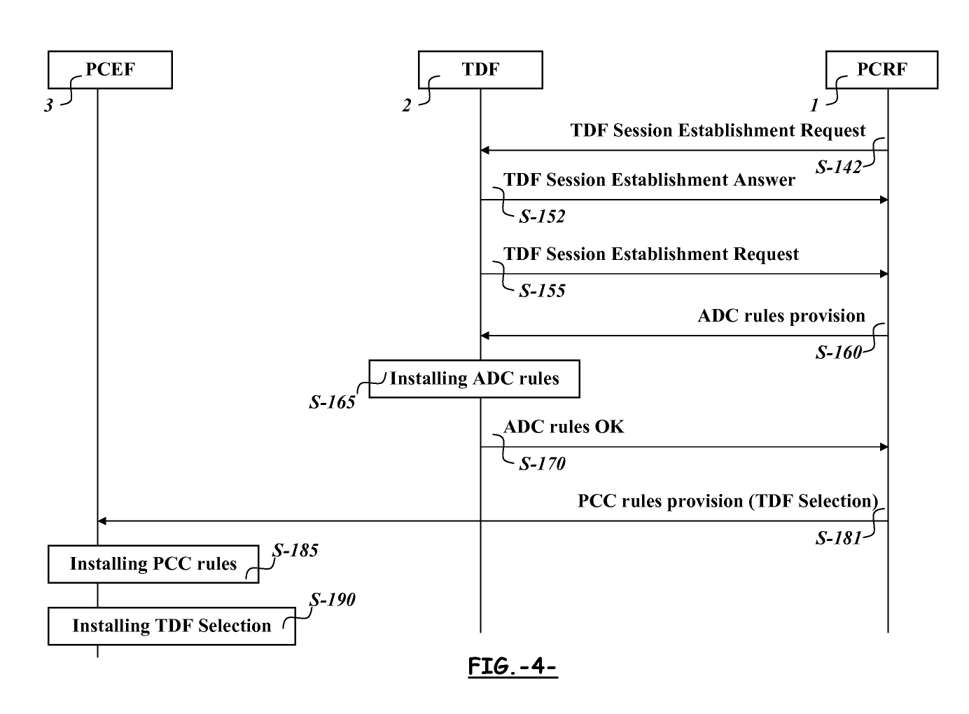

In a second embodiment illustrated in FIG. 4 and in order to initiate the establishment of the TDF session already discussed with reference to FIG. 1, the PCRF server 1 may request to the TDF device 2 during a step 142 the establishment of the TDF session. The TDF device 2 may optionally acknowledge the request during a step S-152, and may correspondingly request during a step S-155 the establishment of the TDF session to the PCRF server 1.

In particular, the PCRF server 1 may submit the ADC rules during the step S-160 along with the request for establishment of the TDF session during the step S-142 to the TDF device 2, which is not illustrated in any drawing, or the PCRF server 1 may submit the ADC rules during the step S-160 as a response to receiving during the step S-155 the request for establishment of the TDF session from the TDF device 2, as commented above with reference to the embodiment illustrated in FIG. 3.

To this end, and with reference to FIG. 7, the second interface unit 50 of the PCRF server 1 may be arranged for requesting the establishment of the TDF session to the TDF device 2. This second interface unit 50 of the PCRF server 1 may optionally be arranged for receiving the acknowledge to the request and also for receiving a request for establishment of the TDF session from the TDF device 2. In particular for this embodiment, the second interface unit 50 may be arranged for submitting the ADC rules to the TDF device 2 along with the request for the establishment of the TDF session submitted from the PCRF server 1 to the TDF device 2.

Also to this end, and with reference to FIG. 8, the interface unit 35 of the TDF device 2 may be arranged for receiving the request for establishment of the TDF session from the PCRF server 1. Optionally, this interface unit 35 of the TDF device 2 may be arranged for submitting the acknowledge to the request and also for submitting the request for establishment of the TDF session to the PCRF server 1. In particular for this embodiment, the interface unit 35 may be arranged for receiving the ADC rules from the PCRF server 1 along with the request for the establishment of the TDF session received from the PCRF server 1.

Generally speaking, the submission of ADC rules from the PCRF server 1 to the TDF device 2 during the step S-160 may be carried out along with the initiation of the establishment of the TDF session from the PCRF server 1 towards the TDF device 2 during the step S-140, or immediately afterwards without awaiting acknowledgements or requests from the TDF device 2.

If this were the case, the ADC rules might be submitted by the PCRF server 1 to the TDF device 2 along with the notification of the needs for a TDF session submitted during the step S-141, or along with the request for establishment of the TDF session during the step S-142, or as a response to receiving during the step S-155 the request for establishment of the TDF session from the TDF device 2.

Back to the sequence of actions to be carried out in the exemplary embodiment illustrated in FIG. 4, upon receiving the ADC rules, the TDF device 2 installs the ADC rules during a step S-165 and confirms back to the PCRF server 1 the successful installation of ADC rules during a step S-170.

As for the embodiment illustrated with reference to FIG. 3, also under this embodiment, upon determining by the PCRF server 1 the successful installation of the ADC rules during this step S-170, the PCRF server 1 may submit during a step S-181 the PCC rules to the PCEF device 3 along with information related to the selected TDF device 2 for the PCEF device 3 to be enabled to communicate with the TDF device 2 either directly or indirectly though the PCRF server 1. Then, the PCEF device 3 may install the received PCC rules during a step S-185, and may install the received information, if any, related to the selected TDF device 2 during a step S-190.

Likewise and with respective references to FIG. 8 and FIG. 7, the interface unit 35 of the TDF device 2 may be arranged for notifying the PCRF server 1 of a successful installation of the ADC rules for the IP-CAN session, and the processing unit 20 of the PCRF server 1 may be arranged for determining that the ADC rules have successfully been installed at the TDF device 2 and, responsive to this determination, for triggering the submission of the PCC rules through the first interface unit 40 towards the PCEF device 3.

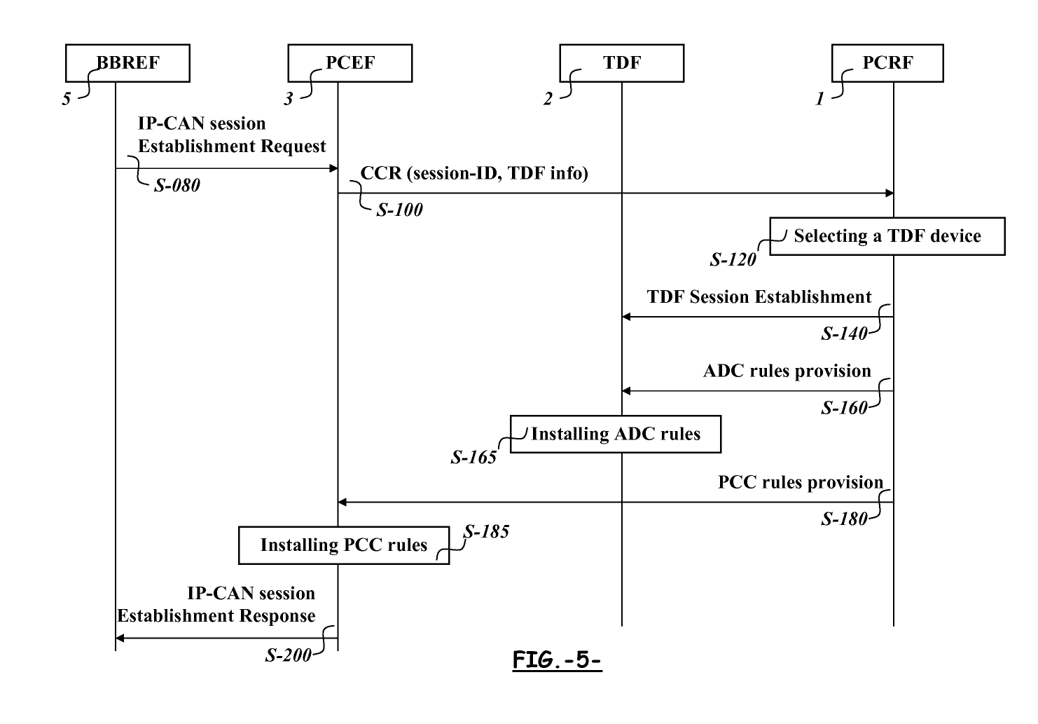

In a third embodiment illustrated in FIG. 5 there is a Bearer Binding and Event Reporting Function (BBERF) server of a PCC architecture in charge of initiating a Gateway Control Session Establishment procedure. In fact, this BBERF server 5 might be involved as well in the above first and second embodiments respectively illustrated in FIGS. 3 and 4.

As shown in FIG. 5, the BBERF server 5 may submit during a step S-090 an IP-CAN session establishment request towards the PCEF device 3. Then, as commented above in respect of FIG. 1, the PCEF device 3 signals the establishment of the IP-CAN session towards the PCRF server 1 during a step S-100. In particular, the PCEF device may provide a session-ID identifying the IP-CAN session, and might also optionally provide TDF-related information useful for the PCRF server to select a TDF device suitable for inspecting traffic through the IP-CAN session. The TDF-related information might be an IP address for addressing a particular TDF device or any other individual or group identifier that the PCRF server could make it use of to select the suitable TDF.

Upon being signalled about the establishment of the IP-CAN session, the PCRF server 1 selects during a step S-120 a TDF device 2 for detecting and reporting traffic through the IP-CAN session.

Then, the PCRF server 1 initiates during a step S-140 the establishment of a TDF session with the selected TDF device 2, and submits the applicable ADC rules to the selected TDF device 2 during a step S-160 either immediately after or along with the establishment of the TDF session carried out during the step S-140. The TDF device 2 installs during a step S-165 the received ADC rules.

Explicitly shown for this embodiment, and also applicable to any above embodiment, the PCRF server 1 may assume that the ADC rules have successfully been installed without needing an explicit message from the TDF device to this end. For example, the PCRF server 1 might wait for an unsuccessful result during a time gap, and the fact of not receiving such an unsuccessful result allows the PCRF server 1 to determine the successful installation of the ADC rules.

Then, the PCRF server 1 may submit during a step S-180 the PCC rules to the PCEF device 3 and the PCEF device may install the received PCC rules during a step S-185. Eventually, the PCEF device 3 returns to the BBERF server 5 an IP-CAN session establishment response during a step S-200.

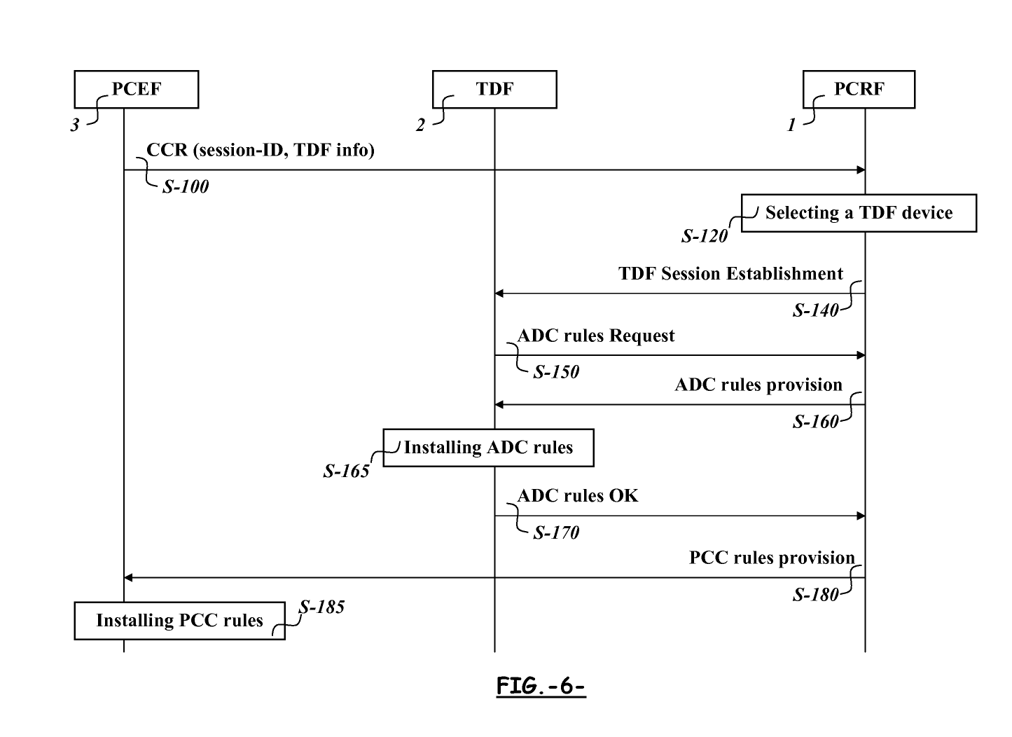

In a fourth embodiment illustrated in FIG. 6 and in order to initiate the establishment of the TDF session already discussed with reference to FIG. 1, upon being signalled about the establishment of the IP-CAN session during the step S-100, the PCRF server 1 selects during the step S-120 a TDF device 2 for detecting and reporting traffic through the IP-CAN session. Then, the PCRF server 1 initiates during a step S-140 the establishment of a TDF session with the selected TDF device 2. In particular, the PCRF server 1 may initiate the establishment of the TDF session by notifying the TDF device of the needs for the TDF session or by sending to the TDF device a TDF session establishment request, as already discussed above with regards to first and second embodiments.

The TDF device 2 may, at any time during the IP-CAN session existence and irrespective of having already received ADC rules, request ADC rules to the PCRF server 1. This embodiment shows the case where after or during the TDF session establishment, at any time during the existence of the IP-CAN session, the TDF device 2 requests ADC rules to the PCRF server during a step S-150. Responsive to this request from the TDF device, the PCRF server 1 may submit during the step S-160 the requested ADC rules to the TDF device 2.

To this end and with reference to FIG. 7, the second interface unit 50 of the PCRF server 1 may be arranged for submitting the ADC rules to the TDF device 2 upon request from the TDF device.

Also to this end and with reference to FIG. 8, the interface unit 35 of the TDF device 2 may be arranged for submitting a request for the ADC rules to the PCRF server 1 at any time during the existence of the IP-CAN session.

Back to the sequence of actions exemplary illustrated in FIG. 6, the TDF device 2 installs during the step S-165 the received ADC rules and submits during the step S-170 a notification to the PCRF server 1 indicating the successful installation of the ADC rules. As determining the successful installation of the PCC rules, the PCRF server 1 may submit during the step S-180 the PCC rules to the PCEF device 3, wherein the PCC rules are installed during the step S-185.

As already commented above with reference to FIG. 8 and FIG. 7 for alternative or complementary embodiments, the interface unit 35 of the TDF device 2 may be arranged for notifying the PCRF server 1 of a successful installation of the ADC rules for the IP-CAN session, and the processing unit 20 of the PCRF server 1 may be arranged for determining that the ADC rules have successfully been installed at the TDF device 2 and, responsive to this determination, for triggering the submission of the PCC rules through the first interface unit towards the PCEF device 3.

The embodiments discussed above disclose specific technical features that can be combined in any manner, included or excluded in any of them, or replaced by equivalent technical features and inasmuch as the actions disclosed with reference to FIG. 1 are accomplished. More precise, alternative or complementary, sub-embodiments or parts thereof are further discussed in the following.

For instance, three sub-embodiments are further provided for by the present invention in order initiate the establishment of a TDF session:

In a first sub-embodiment, a so-called one-time event DCCA may be used when there is no need to maintain any state in the Diameter credit-control server, namely the PCRF server. So, according to this sub-embodiment, the PCRF server sends a CCR message with CC-Request-Type AVP set to EVENT-REQUEST value. The TDF device acknowledges this message, and then initiates the TDF session establishment procedure towards the PCRF server. The PCRF server provides then the ADC rules to the TDF device.

In a second sub-embodiment, instead of making use of the one-time event of the DCCA application, a new Diameter message (such as Session-Start-Request, SSR) could be defined. This message would be sent from the Diameter server (namely, the PCRF server) to the Diameter client (namely, the TDF device). At the reception of this message, the TDF device initiates a Diameter session towards the PCRF server. The PCRF server provides then the ADC rules to the TDF device.

In a third sub-embodiment, the PCRF server may send a non-Diameter message for notifying the TDF device of the need of starting a Diameter session towards such PCRF server. The TDF device will start the Diameter session, and the PCRF server provides then the ADC rules to the TDF device.

Moreover, for the first sub-embodiment, the PCRF server, behaving like Diameter client, will use the one-time event for reporting to the TDF device (acting as Diameter server) the need of establishing a TDF session. Since there is no state going to be maintained, once the one-time event message exchange is finished, the TDF device can initiate the TDF session. And from that point on, the TDF device will act as Diameter client, and the PCRF server as a state-full Diameter Server (providing the ADC Rules to the TDF device).

To this end, the PCRF server sends a Gx CCR, with CC-Request-Type AVP set to EVENT-REQUEST value, to the TDF device. Besides, this message includes a way of identifying the subscriber. For instance: if the subscriber has an IPv4 address assigned, the Framed-IP-Address AVP including such IPv4 address, or if the subscriber has an IPv6 address assigned, the Framed-IPv6-Prefix AVP including the prefix of such IPv6 address.

The TDF device sends a Gx CCA to the PCRF sever in order to acknowledge the reception of the previous Gx CCR. Then, the TDF device requests the establishment of a TDF session to the PCRF server for the indicated subscriber (i.e. IP address). For such purpose, the TDF device sends a Gx CCR, with CC-Request-Type AVP set to INITIAL-REQUEST value, and includes the IP addresses following the above alternatives on IPv4 or IPv6.

At this stage, the PCRF server decides the applicable ADC rules for that IP-CAN session, and stores them. Those ADC rules may be based on subscription profile information fetched from the SPR as generally commented above in respect of other embodiments. Then, the PCRF server provides the applicable ADC rules to the TDF device in the CCA message. The TDF device installs such ADC Rules.

Now, the PCRF server sends a Gx CCR to the PCEF device, including the applicable PCC Rules. Apart from that, the PCRF may initiate a Gateway Control and QoS rule provisioning procedure.

The PCEF device installs the provided PCC Rules and, if the PCRF server has provided a TDF device to handle the IP-CAN session, the PCEF device shall install it. Eventually, the PCEF device acknowledges the IP-CAN session establishment.

Moreover, for the second sub-embodiment, the PCRF server makes use of a new Diameter message, called Session-Start Request (SSR) in the specification. This SSR message is sent from a Diameter Server, namely the PCRF server, to a specific Diameter client, the TDF device. When the TDF device receives such message, and after acknowledging it through another new Diameter message called Session-Start Answer (SSA) in this specification, the TDF device will start the TDF session. In this case, the PCRF server maintains constantly the Diameter server role, and the TDF device maintains the Diameter client role.

The PCRF server sends the Diameter SSR message to the TDF device, including at least one way of identifying the subscriber. For instance: if the subscriber has an IPv4 address assigned, the Framed-IP-Address AVP including such IPv4 address, or if the subscriber has an IPv6 address assigned, the Framed-IPv6-Prefix AVP including the prefix of such IPv6 address.

The TDF acknowledges the reception of such message by means of a Diameter SSA, and the procedure follows as for the first sub-embodiment.

Particularly for this second sub-embodiment, the new SSR and SSA messages may have the following formats and contents:

<SS-Request>::=<Diameter Header: to be defined, REQ, PXY>
<Session-Id>
{Auth-Application-Id}
{Origin-Host}
{Origin-Realm}
{Destination-Realm}
{CC-Request-Type}
{CC-Request-Number}
[Destination-Host]
[Origin-State-Id]
[Framed-IP-Address]
[Framed-IPv6-Prefix]
* [AVP]

<SS-Answer>::=<Diameter Header: to be defined, REQ, PXY>
<Session-Id>
{Auth-Application-Id}
{Origin-Host}
{Origin-Realm}
{Destination-Realm}
{CC-Request-Type}
{CC-Request-Number}
[Destination-Host]
[Origin-State-Id]
*[AVP]

Moreover, for the third sub-embodiment, the PCRF server makes use of a Non-Diameter message notification for triggering the start of the TDF session from the TDF device. For instance, such notification could be a simple ICMP echo request, which is also known as Ping operation, or a more sophisticated HTTP/SOAP request. So when the TDF device receives such notification, the TDF device will initiate the TDF session. Therefore, the TDF device always maintains the Diameter client role, and the PCRF server the Diameter server role.

Thus, the PCRF server sends a notification (e.g. ICMP echo request—Ping operation) to the TDF device reporting the need of establishing a TDF session, including one way of identifying the subscriber, like the subscriber IP address. Then, the TDF device acknowledges the reception of such notification, and the procedure follows as for the first sub-embodiment.

The invention may also be practised by a computer program, loadable into an internal memory of a computer with input and output units as well as with a processing unit. This computer program comprises to this end executable code adapted to carry out the above method steps when running in the computer. In particular, the executable code may be recorded in a carrier readable means in a computer.

The invention is described above in connection with various embodiments that are intended to be illustrative and non-restrictive. It is expected that those of ordinary skill in this art may modify these embodiments. The scope of the invention is defined by the claims in conjunction with the description and drawings, and all modifications that fall within the scope of the claims are intended to be included therein.

1. A method of establishing a Traffic Detection Function “TDF” session in a Policy and Charging Control “PCC” architecture with a Policy and Charging control Rules Function “PCRF” server, a Policy and Charging Enforcement Function “PCEF” device and a TDF device, the method comprising the steps of:
signalling an IP Connectivity Access Network “IP-CAN” session establishment from a PCEF device towards a PCRF server;
selecting at the PCRF server a TDF device for detecting and reporting traffic through the IP-CAN session;
initiating from the PCRF server establishment of a TDF session with the TDF device;
submitting from the PCRF server towards the TDF device Application and Detection Control “ADC” rules to be installed for the IP-CAN session; and
submitting from the PCRF server towards the PCEF device PCC rules to be installed for the IP-CAN session.

2. The method of claim 1, further comprising a step of determining at the PCRF server that the ADC rules have been successfully installed at the TDF device.

3. The method of claim 2, wherein the step of submitting the PCC rules is responsive to the step of determining that the ADC rules have successfully been installed at the TDF device.

4. The method of claim 1, wherein the step of initiating the establishment of the TDF session includes a step of requesting from the PCRF server to the TDF device the establishment of the TDF session.

5. The method of claim 1, wherein the step of initiating the establishment of the TDF session includes a step of notifying from the PCRF server the needs for a TDF session to the TDF device and a step of requesting the establishment of the TDF session from the TDF device to the PCRF server.

6. The method of claim 1, wherein the step of submitting the ADC rules is carried out during the step of initiating from the PCRF server the establishment of the TDF session towards the TDF device.

7. The method of claim 4, wherein the step of submitting the ADC rules is carried out during the step of requesting from the PCRF server to the TDF device the establishment of the TDF session.

8. The method of claim 5, wherein the step of submitting the ADC rules is responsive to the step of requesting the establishment of the TDF session from the TDF device to the PCRF server.

9. The method of claim 1, wherein the step of submitting the ADC rules is responsive to a step of requesting ADC rules from the TDF device to the PCRF server.

10. The method of claim 1, wherein the step of selecting a TDF device at the PCRF server includes a step of receiving TDF information during the step of signalling the IP-CAN session establishment from the PCEF device.

11. The method of claim 1, wherein the step of selecting a TDF device at the PCRF server includes a step of obtaining TDF information from a Subscriber Profile Repository “SPR” in charge of subscription information for a subscriber related to the IP-CAN session.

12. A Policy and Charging control Rules Function “PCRF” server of a Policy and Charging Control “PCC” architecture with a Policy and Charging Enforcement Function “PCEF” device and a Traffic Detection Function “TDF” device (2), the PCRF server comprising:
a first interface unit for signalling establishment of an IP Connectivity Access Network “IP-CAN” session from a PCEF device;
a processing unit for selecting a TDF device to detect and report traffic through the IP-CAN session, for determining PCC rules to be installed at the PCEF device, and for determining Application and Detection Control “ADC” rules to be installed at the TDF device;
a second interface unit for initiating establishment of a TDF session with the TDF device and for submitting towards the TDF device the ADC rules to be installed for the IP-CAN session; and
the first interface unit arranged for submitting towards the PCEF device the PCC rules to be installed for the IP-CAN session.

13. The PCRF server of claim 12, wherein the processing unit is arranged for determining that the ADC rules have successfully been installed at the TDF device and, responsive to this determination, for triggering the submission of the PCC rules through the first interface unit towards the PCEF device.

14. The PCRF server of claim 12, wherein the second interface unit is arranged for requesting the establishment of the TDF session to the TDF device.

15. The PCRF server of claim 12, wherein the second interface unit is arranged for notifying the TDF device of the needs for a TDF session, and for receiving a request for establishment of the TDF session from the TDF device.

16. The PCRF server of claim 14, wherein the second interface unit is arranged for submitting the ADC rules to the TDF device along with the request for the establishment of the TDF session.

17. The PCRF server of claim 15, wherein the second interface unit is arranged for submitting the ADC rules to the TDF device upon receiving the request for establishment of the TDF session from the TDF device.

18. The PCRF server of claim 12, wherein the second interface unit is arranged for submitting the ADC rules to the TDF device upon request from the TDF device.

19. The PCRF server of claim 12, wherein the processing unit is arranged for selecting the TDF device by processing TDF information received at the first interface unit from the PCEF device along with the signalled IP-CAN session establishment.

20. The PCRF server of claim 12, further comprising a third interface unit for obtaining TDF information from a Subscriber Profile Repository “SPR” in charge of subscription information for a subscriber related to the IP-CAN session, and wherein the processing unit is arranged for selecting the TDF device by processing the TDF information obtained at the third interface unit from the SPR.

21. A Traffic Detection Function “TDF” device of a Policy and Charging Control “PCC” architecture with a Policy and Charging control Rules Function “PCRF” server and a Policy and Charging Enforcement Function “PCEF” device, the TDF device comprising:
an interface unit for initiating establishment of a TDF session with a PCRF server, and for receiving Application and Detection Control “ADC” rules for an IP Connectivity Access Network “IP-CAN” session from the PCRF server;
a processing unit for installing the ADC rules for the IP-CAN session; and
a detector for detecting traffic through the IP-CAN session based on the installed ADC rules.

22. The TDF device of claim 21, wherein the interface unit is arranged for notifying the PCRF server of a successful installation of the ADC rules for the IP-CAN session.

23. The TDF device of claim 21, wherein the interface unit is arranged for receiving a request for establishment of the TDF session from the PCRF server.

24. The TDF device of claim 23, wherein the ADC rules are received at the interface unit from the PCRF server along with the request for establishment of the TDF session.

25. The TDF device of claim 21, wherein the interface unit is arranged for receiving a notification of the needs for a TDF session from the PCRF server, and for submitting a request for establishment of the TDF session to the PCRF server.

26. The TDF device of claim 25, wherein the ADC rules are received at the interface unit from the PCRF server as a result of submitting the request for establishment of the TDF session to the PCRF server.

27. The TDF device of claim 21, wherein the interface unit is arranged for submitting a request for the ADC rules to the PCRF server at any time during the existence of the IP-CAN session.

28. A computer program, loadable into an internal memory of a computer with input and output units as well as with a processing unit, the computer program adapted to carry out the method steps according to claim 1 when running in the computer.

29. The computer program of claim 28, recorded in a carrier readable in a computer.
